(19) United States
(12) Patent Application Publication
(10) Pub. No.: US 2016/0124508 A1
(43) Pub. Date: May 5, 2016

(54) WATERPROOF TOUCHSCREEN GLOVE

(71) Applicant: Danalco, Inc., Lynnwood, WA (US)

(72) Inventors: Amy E. Williams, Seattle, WA (US); Cole Williams, Kirkland, WA (US); Jorge T. Cabadas, Lynnwood, WA (US)

(21) Appl. No.: 14/924,647

(22) Filed: Oct. 27, 2015

Related U.S. Application Data
(60) Provisional application No. 62/073,862, filed on Oct. 31, 2014.

(51) Int. Cl. G06F 3/01; A41D 19/00

(52) U.S. Cl. CPC G06F 3/014; A41D 19/0006; G06F 2203/0331; A41D 2500/10

(57) ABSTRACT

Waterproof touchscreen gloves and associated clothing articles and methods of manufacturing the same are disclosed herein. In one embodiment, a waterproof touchscreen glove comprises an electrically conductive inner layer defining an interior region that receives a user hand, an electrically conductive outer layer, and a substantially continuous and unpenetrated waterproof layer between the inner layer and the outer layer.

### CROSS-REFERENCE TO RELATED APPLICATION

The present application claims the benefit of and priority to Provisional U.S. Patent Application No. 62/073,862, titled Waterproof Touchscreen Glove, filed Oct. 31, 2014, and which is incorporated herein in its entirety by reference thereto.

### TECHNICAL FIELD

The present disclosure relates to gloves and related clothing articles. Particular embodiments are directed to waterproof touchscreen gloves that enable the user to operate a touchscreen with a gloved hand.

### BACKGROUND

Gloves can be made from thermally insulative materials that hold heat within the glove to warm the user's hand. Some gloves can also include an internal waterproof membrane that prevents water from passing through the glove to the user's hand. Typically, when a user is wearing a traditional glove, it is not possible for the user to operate a capacitive touchscreen device (e.g., a mobile phone, tablet, other personal digital assistant, etc.) because the glove's materials electrically isolate the user's fingertips from the touchscreen.

Relatively recently gloves have been made with electrically conductive portions in the fingertips to enable a user to operate a touchscreen device without having to remove the glove. Such conventional gloves, referred to as touchscreen gloves, typically include an electrically conductive material with an outside surface located on the exterior side of the glove and inside surface proximate the glove's fingertip regions. The conductive material electrically contacts the user's fingertip inside the glove to provide a path for electricity between the glove's inside and outside surfaces at the fingertip region. The electrical contact with the user's fingertip enables the capacitive touchscreen to register a user's touch on the screen.

In some conventional touchscreen gloves, especially in thicker insulative and/or waterproof gloves, penetrations are made through the glove's waterproof material, such as in the glove's fingertip region to accommodate an electrically conductive material. One drawback of these types of touchscreen gloves is that water can sometimes pass into the glove's interior through the penetrations, such as in the glove's fingertip regions. In the case of waterproof touchscreen gloves, the penetrations may also weaken the waterproof membrane and cause it to rupture or tear during use.

### BRIEF DESCRIPTION OF THE DRAWINGS

FIG. 1A is a top view of a palm side of a waterproof touchscreen glove in accordance with an embodiment of the present technology.

FIG. 1B is a cross-sectional view of the glove taken substantially along line 1B-1B of FIG. 1A.

FIG. 2 is a cross-sectional view of a finger portion of the touchscreen glove of FIG. 1A positioned proximate to a touchscreen surface of a touchscreen device.

FIG. 3A is a top view of a palm side of a waterproof touchscreen glove in accordance with another embodiment of the present technology.

FIG. 3B is a cross-sectional view of the glove taken substantially along line 3B-3B of FIG. 3A.

### DETAILED DESCRIPTION

The following disclosure describes various types of electrically conductive waterproof gloves and associated clothing articles and methods of manufacturing the same. For example, a waterproof touchscreen glove configured in accordance with the various embodiments of the technology can include a substantially continuous and unperforated or unpenetrated waterproof layer sandwiched between electrically conductive outer and inner layers. The conductive layers enable the registration of a user's touch on a touchscreen device, and the waterproof layer prevents water and moisture from passing into the glove's interior through the glove's outer conductive layer. As described in greater detail below, the waterproof layer does not require perforations or other penetrations, openings, or interruptions in the waterproof layer in the fingertip regions (or other regions of the glove) to enable a user's touch to register on a capacitive touchscreen device, such as a mobile device, a tablet, a display, etc.

An aspect of the technology provides a waterproof touchscreen hand covering, comprising an electrically conductive inner layer defining an interior region that receives a user hand; an electrically conductive outer layer; and a substantially continuous and unpenetrated waterproof layer between the inner layer and outer layer, wherein the waterproof layer is substantially non-electrically conductive. The hand covering can be a glove with a body portion and finger portions connected to the body portion. The inner layer can be electrically insulated from the outer layer throughout the body portion of the glove as well as throughout the finger portions. In at least one embodiment, a waterproof, touchscreen glove assembly comprises an electrically conductive inner layer with a first body portion and first finger portions. An electrically conductive outer layer has a second body portion in alignment with the first body portion and second finger portions in alignment with the first finger portions. A substantially non-electrically conductive, continuous, and unpenetrated waterproof layer is between the inner layer and outer layer, and wherein the glove assembly is configured for registration of a user's touch on a touchscreen device. The inner and outer layers can each comprise a fabric having a plurality of conductive fibers. At least one of the inner or outer layers can include a knit glove. The glove assembly can further comprise an insulative inner liner attached to an inner surface of the inner layer to be between the inner layer and a user's hand when a user is wearing the glove assembly. The glove assembly can have reinforcement layers attached to an exterior surface of the outer layer.

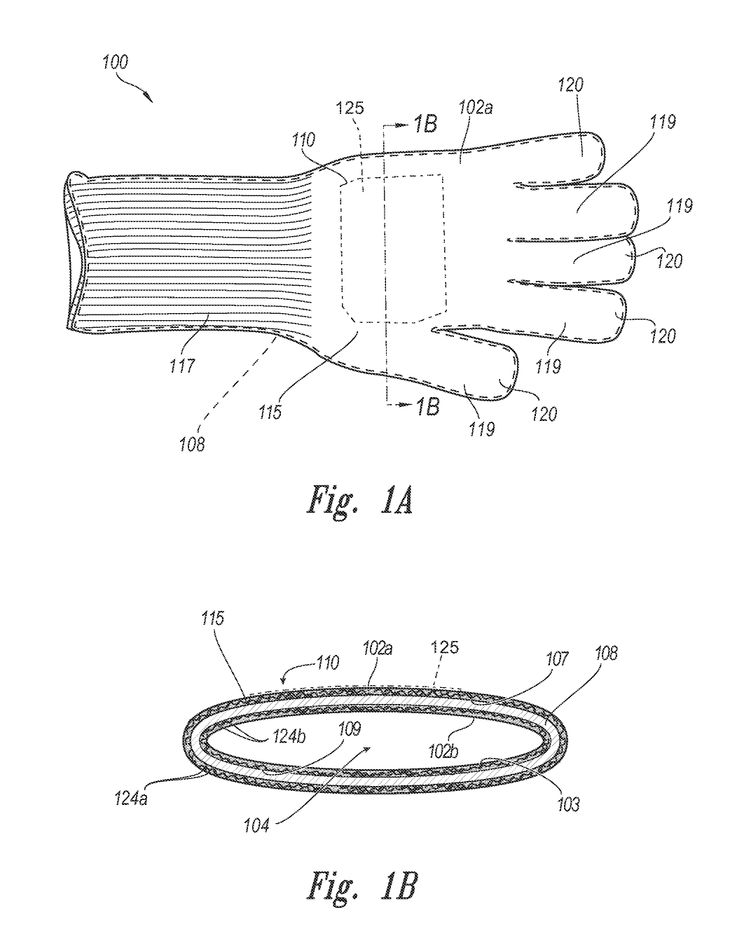

Specific details of several embodiments of the technology are described below with reference to FIGS. 1A-3B. Other details describing well-known structures and systems often associated with gloves and related clothing articles have not been set forth in the following disclosure to avoid unnecessarily obscuring the description of the various embodiments of the technology. Many of the details, dimensions, angles, and other features shown in the Figures are merely illustrative of particular embodiments of the technology. Accordingly, other embodiments can have other details, dimensions, angles, and features without departing from the spirit or scope of the present technology. A person of ordinary skill in the art, therefore, will accordingly understand that the technology may have other embodiments with additional elements, or the technology may have other embodiments without several of the features shown and described below with reference to FIGS. 1A-3B.

FIG. 1A is a top view of a palm side 110 of a waterproof touchscreen glove 100 (“glove 100”), and FIG. 1B is a cross-section view of the glove 100 taken substantially along line 1B-1B of FIG. 1A in accordance with an embodiment of the technology. Referring to FIGS. 1A and 1B together, the glove 100 includes a waterproof layer 108 sandwiched between an electrically conductive outer layer 102a (e.g., a shell component) and an electrically conductive inner layer 102b (FIG. 1B; e.g., a liner component). The inner layer 102b defines an interior region 104 that receives a user's hand into the glove 100. As shown, the outer layer 102a has a palm portion 115, a cuff or forearm portion 117 proximal to the palm portion 115, and a plurality of finger portions 119 with corresponding fingertip regions 120 distal to the palm portion 115.

The waterproof layer 108 includes a substantially continuous and unperforated or otherwise unpenetrated material forming a waterproof or water-resistant barrier between the outer layer 102a and the inner layer 102b and extending distally from the glove's forearm portion 117 to the glove's outer fingertip regions 120. In one embodiment, the waterproof layer 108 is substantially unpenetrated through the body of the glove. In another embodiment, the waterproof layer 108 is substantially unpenetrated at least in the glove's palm portion 113 and finger portions 119. In at least some embodiments, the waterproof layer 108 can be attached (e.g., spot attached) to an inward facing surface 107 (FIG. 1B) of the outer layer 102a and an outward facing surface 109 (FIG. 1B) of the inner layer 102b.

In one embodiment, the waterproof layer 108 is formed by a glove-shaped, continuous, unpenetrated seamless bladder. In an alternate embodiment, the waterproof layer 108 includes two or more sheets of waterproof material (e.g., a palm-side sheet and a back-side sheet) welded together to form a continuous layer of material without any perforations or other penetrations that may allow water to pass inwardly to the inner layer 102b. The waterproof layer 108 can be composed of any of a variety of suitable materials for forming a waterproof or water resistant seal or barrier. For example, in one embodiment, the waterproof layer 108 comprises thermoplastic polyurethane. In another embodiment, the waterproof layer 108 can be a semipermeable, breathable layer composed of a microporous Polytetrafluoroethylene (PTFE)-based membrane (e.g., Gore-Tex®) that releases moisture from the user's hand through the membrane, yet prevents water from flowing into the glove in the opposite direction toward the inner layer 102b.

The outer and inner layers 102a-b are electrically conductive fabric layers having a plurality of electrically conductive fibers 124a and 124b, respectively, interspersed throughout. The conductive fibers 124a-b can include any of a variety of conductive or semi-conductive materials, such as silver-coated nylon fibers, copper-coated fibers, stainless steel filaments, or conductive carbon fibers. As discussed in greater detail below, the user's hand can be electrically coupled to the conductive inner layer 102b when the user's hand engages the inner layer, thereby engaging the conductive fibers 124b, such as when the user's fingertip regions engage the fingertip portions of the inner layer.

In at least some embodiments, the conductive fibers 124a-b are incorporated into the yarns of the outer and inner layers 102a-b. Such yarns can be knit, woven, or otherwise formed from textile materials, including cotton, wool, polyester, synthetics, Kevlar®, nylon, or other suitable materials selected to provide suitable warmth and/or protection for the user's hand. For example, in one embodiment the yarns of the outer and/or inner layers 102a-b can incorporate aramid fibers, such as the flame-resistant Nomex® produced by E. I. du Pont de Nemours and Company. In another embodiment, the yarns of the outer and/or the inner layers 102a-b can incorporate elastic fibers (e.g., Lycra® spandex fibers made by Invista, Inc.). Yarns incorporating elastic fibers can be used to provide good stretch and return characteristics (e.g., elasticity) which provide good form fitting (e.g., close fitting to the human hand) and allow a single-sized glove to comfortably fit a variety of hand sizes.

In a number of embodiments, the outer and/or inner layers 102a-b are seamless one piece gloves that can be produced, for example, using conventional computer-controlled knitting machines. In a particular embodiment, the outer layer 102a can be a knit glove having a selected gauge, such as an ultrafine gauge (e.g. from about 10 gauge to about 18 gauge). In at least some embodiments, the outer and inner layers 102a-b are manufactured using cut-and-sew techniques wherein portions of the selected layer are cut from a sheet of electrically conductive material and sewn together to form the selected outer or inner layer. The waterproof layer 108 can be captured between the inner and outer layers 102a-b via a selected adhesive, such as in a manner disclosed in Applicant's U.S. Pat. No. 5,832,539, which is incorporated herein in its entirety by reference thereto.

In the illustrated embodiment, the outer layer 102a is electrically insulated from the inner layer 102b throughout the glove area via the waterproof layer 108. However, it is not necessary for the outer and inner layers 102a-b to be electrically insulated from one another. For example, in one embodiment, the outer layer 102a can be in physical contact with the inner layer 102b toward the cuff of the glove's forearm portion 117. In such an embodiment, the waterproof layer 108 may stop short of the glove's cuff.

As shown in FIG. 1A in broken lines, the glove 100 can include additional layers of material 125 at the glove's exterior and/or within the glove's interior. For example, in at least some embodiments, the glove 100 can include leather finger pads or palm pads that can be bonded or otherwise affixed to the outer layer 102a, polyvinyl emulsion printed and cured onto the glove palm to enhance the gripping surface, rubber-like foam material (e.g., neoprene) to shock-isolate the palm of the hand from vibrations (e.g., from a jack-hammer), or heavier weight material on the back of the glove than on the palm (or vice-versa) to increase thermal insulation. The glove 100 can also include reinforced portions on the places of the glove most likely to be abused or abraded, or areas that are used to grip items or protect a person's hand. In these and other embodiments, one or more additional layers of material can at least partially cover the inner layer 102b within the glove's interior region 104. For example, in at least some embodiments, a thermally insulative liner (e.g., a fleece liner) can be attached to an interior surface 103 of the inner layer 102b with an adhesive or suitable attachment means. For example, a liner, such as a fleece liner, can be incorporated into the glove 100 as disclosed in Applicant's U.S. Patent Application Publication No. 2013/0232662, titled “Lined Clothing Articles and Methods of Manufacturing,” which is incorporated herein in its entirety by reference thereto In a number of these embodiments, the insulative liner is configured such that it does not interfere with the electrical contact between the user's fingertips and the portions of the inner layer 102b, such as at the glove's fingertip regions 120. For example, the palm side of the insulative liner may extend only up to approximately the knuckle of the user's thumb and/or the second knuckle of one or more of the user's fingers.

In use, the glove 100 enables a user to operate a touchscreen device without having to remove the glove. As discussed below, when the user's gloved hand touches the touchscreen, the portion of the glove in contact with the screen produces electrical interference (e.g., an electric field) that can be registered by the touchscreen. For example, the touchscreen can register when one or more of the fingertip regions 120 touch the touchscreen. In at least some instances, the touchscreen can also register when the palm or other portion of the glove, such as a portion of the glove covering a knuckle portion of the user's hand, contacts the touchscreen.

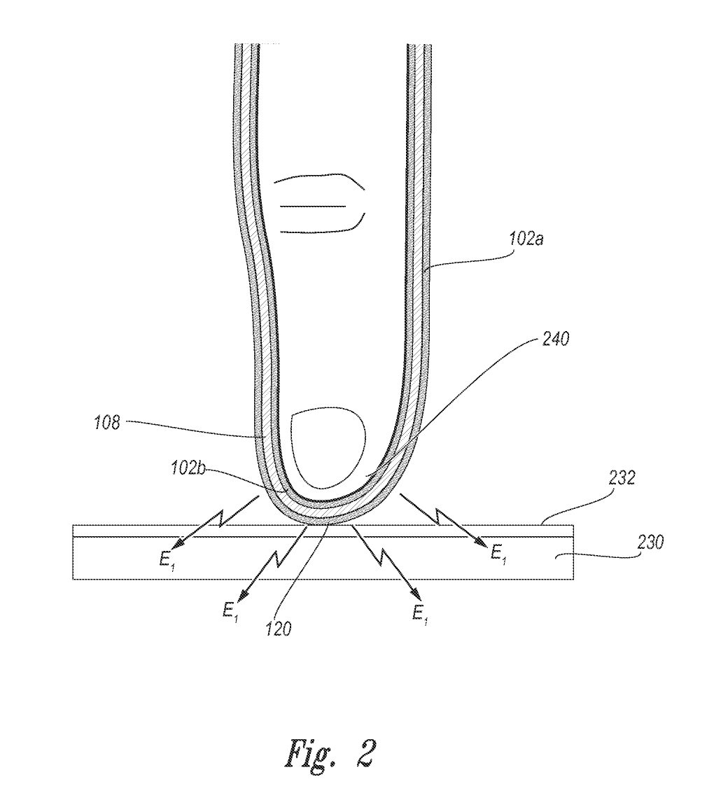

FIG. 2 is a cross-sectional view of one of the glove's finger portions 119 (e.g., the index finger portion) positioned proximate to a capacitive touchscreen device 230 (e.g., a surface-capacitive or a projected-capacitive touchscreen) in accordance with an embodiment of the present technology. The touchscreen device 230 includes a touchscreen surface 232 and touch sensors (e.g., transparent electrodes; not shown) configured to sense skin contact with the touchscreen surface 232. In operation, a touch sensor typically registers a user's touch by detecting electrical interference (e.g., an electric field or flux) produced by a user's fingertip 240 when it is in the vicinity of the touchscreen surface 232. In general, the electrical interference is caused by the free electrical charge that is normally present on the surface of a user's skin. When the user touches the touchscreen, the free charge at the fingertip 240 can draw a small amount of electrical current from the touchscreen surface 232 near the point of contact. In a typical capacitive touchscreen device, the small electrical current at the point of contact creates a localized voltage shift (e.g., a voltage drop) which the touchscreen device can detect to determine the location of the user's fingertip 240 on the screen. In the example of FIG. 2, the electrical charge (not shown) at the user's fingertip 240 produces an electric field, E₁, that emanates outwardly from the glove's fingertip region 120 and generally toward the touchscreen surface 232. As shown, the electric field E₁ passes through the waterproof layer 108.

In general, the conventional understanding in touchscreen glove technology is that the user's fingertip needs to be in direct electrical contact with the touchscreen in order for it to register a touch. That is, there needs to be an electrical path through which electrical current can flow directly between the touchscreen and the skin of the user's fingertip. In contravention to this conventional understanding, however, gloves configured in accordance with the present technology can produce electrical interference detectable by a touchscreen device without the need for such direct electrical contact between the touchscreen and the user's fingertip.

Without being bound by theory, the glove 100 can produce detectable electrical interference even though the user's fingertip 240 is electrically separated from the conductive outer layer 102a by the electrically non-conductive waterproof layer 108. In at least some embodiments, the waterproof layer 108 can be configured such that it does not substantially impede (or completely block) the electric field E₁ emanating from the user's fingertip 240. For example, in one embodiment, the waterproof layer 108 can have a thickness that is less than or equal to about 5 mil. In other embodiments, a suitably thin waterproof layer may have a thickness that is less than or equal to about 1 mil.

In one aspect of the illustrated embodiment, the glove 100 does not require penetrations, such as perforations or other openings, made through the fingertip regions 120 to form an electrical connection (i.e., an electrical current path) with the skin of the user's fingertip 240. As such, the glove 100 can provide waterproof protection in a manner that is superior to conventional waterproof touchscreen gloves having such perforations or openings. Further, because the waterproof layer 108 is continuous at the glove's fingertip regions 120, it is less likely to rupture or tear during use compared to such conventional gloves. In another aspect of this embodiment, methods of manufacturing the touchscreen glove 100 can be less complicated and less expensive than those used to manufacture conventional waterproof touchscreen gloves because there is no need to form openings in the fingertip regions 120.

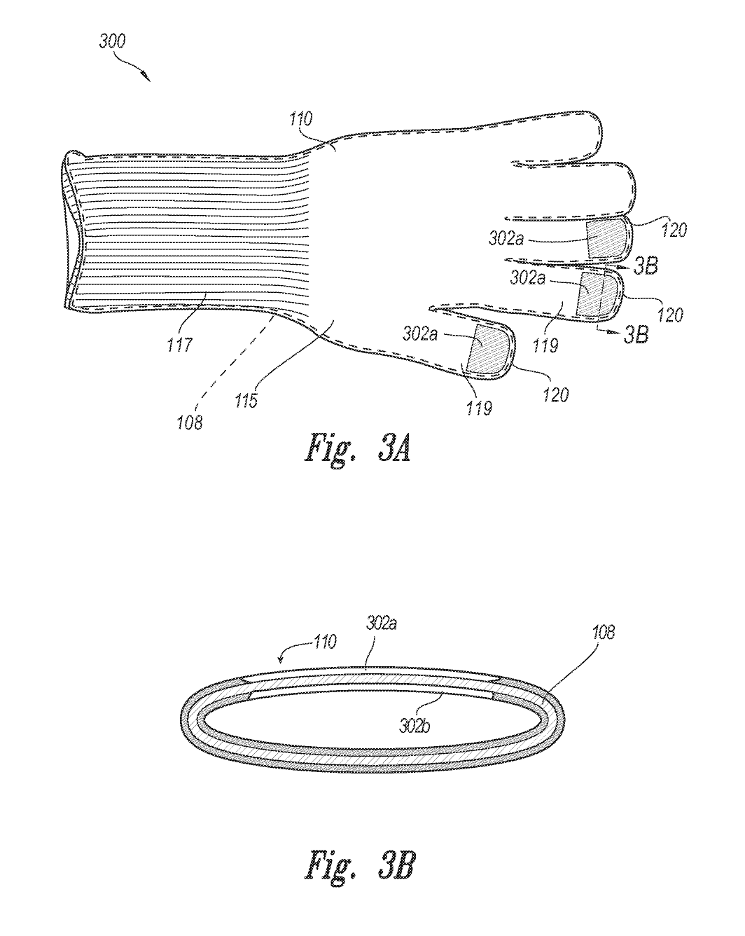

In the embodiments described above, the touchscreen glove 100 includes outer and inner layers 102a-b that are continuous and electrically conductive throughout the body of the glove. However, waterproof touchscreen gloves configured in accordance with other embodiments of the present technology may include localized electrically conductive regions that function in a manner generally similar to the conductive layers 102a-b, but do not extend throughout the body of the glove. For example, referring to FIGS. 3A and 3B, a waterproof touchscreen glove 300 can include discrete outer conductive pads 302a and corresponding inner conductive pads 302b (FIG. 3B) located at certain fingertip regions 120 and at opposite sides of the waterproof layer 108. The conductive pads 302a-b can include, for example, conductive materials (e.g., conductive fabrics, yarns, fibers) that are integrated into selected regions of the glove 300. In additional or alternate embodiments, a conductive material can be cut to shape and attached to selected regions of the glove with an adhesive, thread, or suitable attachment means.

From the foregoing, it will be appreciated that specific embodiments of the invention have been described herein for purposes of illustration, but that various modifications may be made without deviating from the spirit and scope of the invention. For example, although described in the context of a glove, the new technology can be incorporated into a myriad of different types of hand coverings (e.g., mittens) or related clothing articles, such as a hand covering attached to or integrated with the end of a sleeve (e.g., the sleeve of a t-shirt, sweater, coat, jacket, etc.). Further, certain aspects of the new technology described in the context of particular embodiments may be combined or eliminated in other embodiments. Moreover, while advantages associated with certain embodiments of the technology have been described in the context of those embodiments, other embodiments may also exhibit such advantages, and not all embodiments need necessarily exhibit such advantages to fall within the scope of the invention. Accordingly, the disclosure and associated technology can encompass other embodiments not expressly shown or described herein. Thus, the disclosure is not limited except as by the appended claims.

I claim:

1. A hand covering, comprising:
an electrically conductive inner layer defining an interior region that receives a user hand;
an electrically conductive outer layer; and
a substantially continuous and unpenetrated waterproof layer between the inner layer and outer layer, wherein the waterproof layer is substantially non-electrically conductive.

2. The hand covering of claim 1 wherein the conductive outer layer has five fingertip regions, and wherein the waterproof layer is substantially continuous and unperforated throughout each of the fingertip regions.

3. The hand covering of claim 1 wherein hand covering is a glove with a body portion and finger portions connected to the body portion, the inner layer is electrically insulated from the outer layer throughout the body portion of the glove.

4. The hand covering of claim 1 wherein the inner and outer layers each comprise a fabric having a plurality of conductive fibers.

5. The hand covering of claim 1 wherein the inner layer includes a knit glove layer.

6. The hand covering of claim 5 wherein the outer layer includes a knit glove layer.

7. The hand covering of claim 1 wherein the inner and outer layers each comprise a plurality of conductive yarns each having a plurality of integral conductive fibers.

8. The hand covering of claim 1 wherein the waterproof layer comprises a water resistant material.

9. The hand covering of claim 1 wherein the waterproof layer comprises a semipermeable membrane.

10. The hand covering of claim 1 wherein the waterproof layer has thickness that is less than or equal to about 5 mil.

11. The hand covering of claim 1 wherein the waterproof layer has thickness that is less than or equal to about 1 mil.

12. The hand covering of claim 1 wherein the waterproof layer has a thickness selected such that the waterproof layer does not substantially impede an electric field emanating generally from a user's finger when the user is wearing the glove.

13. The hand covering of claim 1, further comprising an insulative inner liner attached to an inner surface of the inner layer to be between the inner layer and a user's hand when a user is wearing the glove assembly.

14. A waterproof touchscreen glove assembly, comprising:
an electrically conductive inner layer defining an interior region that receives a user hand, the inner layer having a first body portion and first finger portions;
an electrically conductive outer layer having a second body portion in alignment with the first body portion and second finger portions in alignment with the first finger portions; and
a substantially continuous and unpenetrated waterproof layer between the inner layer and outer layer, the waterproof layer having a third body portion intermediate the first and second body portions, and having third finger portions intermediate the first and second finger portions, wherein the waterproof layer is substantially non-electrically conductive, and wherein the glove assembly is configured for registration of a user's touch on a touchscreen device.

15. The glove assembly of claim 14 wherein the second finger portions has five fingertip regions, and wherein the waterproof layer is substantially continuous and unpenetrated throughout each of the fingertip regions.

16. The glove assembly of claim 14 wherein the inner and outer layers each comprise a fabric having a plurality of conductive fibers.

17. The glove assembly of claim 14 wherein at least one of the inner or outer layers includes a knit glove.

18. The glove assembly of claim 14 wherein the inner and outer layers each comprise a plurality of conductive yarns each having a plurality of integral conductive fibers.

19. The glove assembly of claim 14, further comprising an insulative inner liner attached to an inner surface of the inner layer to be between the inner layer and a user's hand when a user is wearing the glove assembly.

20. The glove assembly of claim 14, further comprising at least one of the reinforcement layers attached to an exterior surface of the outer layer.
